(19) United States
(12) Patent Application Publication
(10) Pub. No.: US 2003/0020717 A1
(43) Pub. Date: Jan. 30, 2003

(54) Device for defining a shape of structural object, method of defining a shape of a structural object, program for defining a shape of a structural object, and device for creating design drawings of a structural object

(75) Inventor: Akira Onodera, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Tokyo (JP)

(21) Appl. No.: 10/207,207

(22) Filed: Jul. 30, 2002

(30) Foreign Application Priority Data
Jul. 30, 2001 (JP) 2001-230138

(51) Int. Cl. G06T 17/00

(52) U.S. Cl. 345/441

(57) ABSTRACT

Component information relating to components forming a structural object in virtual space realized by a computer is stored beforehand; information of desired components of these stored items of component information is selected; the dimensions of desired portions are set; a joining surface of each component is designated; the components are joined; and, finally, wall thickness is determined. In this way, even if there is a request for definition of a shape such as that of an underground structural object which departs greatly from previously defined shapes, shape definition can be performed in a flexible fashion and as far as possible without lowering the operational efficiency of definition of the shape of the structural object.

### TITLE OF THE INVENTION

Device for defining a shape of a structural object, method of defining a shape of a structural object, program for defining a shape of a structural object, and device for creating design drawings of a structural object

### CROSS REFERENCE TO RELATED APPLICATION

This application claims benefit of priority to Japanese application number JP 2001-230138 filed Jul. 30, 2001, the entire content of which is incorporated by reference herein.

### BACKGROUND OF THE INVENTION

1. Field of the Invention

The present invention relates to a device used for defining a shape of a structural object such as a manhole in virtual space realized by a computer, a method of defining a shape of a structural object, a program for defining a shape of a structural object. The present invention also relates to a device for creating design drawings using the shape of the structural object defined by the device for defining the shape of a structural object, a method of creating design drawings, and a program for creating design drawings.

2. Description of the Related Art

Conventionally, when excavating roads and the like, a hollow portion such as a hole or trench is formed in the ground, and underground structural objects such as manholes are buried in this hollow portion.

Also, when an order for defining the shape of underground structural objects is received from a client, the shape of the underground structural object (hereinbelow termed the “pre-defined shape”) defined beforehand as shown in FIG. 1 is presented to the client. As shown in FIG. 1A, FIG. 1B and FIG. 1C, example existing pre-defined shapes are rectangular prism shape, L-shaped or T-shaped etc. Specifications of the dimensions of the various portions were then obtained from the client and the shape of structural objects such as underground structural objects was then defined in virtual space realized by a computer, using these specified dimensions.

However, in recent years, in particular in towns and cities, underground buried objects of various shapes such as electrical communication conduits, gas pipes, water pipes, and sewage pipes are becoming necessary, so requests for definition of shapes of underground structural objects that are markedly different from these pre-defined shapes are often received from clients. In such cases, the predefined shape must be redefined on each occasion so this tends to cause a loss in the efficiency of the operation relating to definition of the shapes of structural objects and the problem of lack of flexibility of shape definition arose.

### SUMMARY OF THE INVENTION

Accordingly, one object of the present invention is to provide novel means whereby, even when requests for definition of shape of underground structural objects etc. are made that depart greatly from the existing pre-defined shapes, such shape definition can be performed with as little as possible lowering of the efficiency of the operation of defining structural shapes and in a flexible fashion.

In order to achieve the above object, the present invention is constructed as follows. Specifically, a structural object shape definition device for defining a shape of a structural object such as a manhole in virtual space realized by a computer, comprises:

a component information storage unit that stores component information relating to components that form said structural object;

a component information selection unit that selects desired component information from the component information stored in the component information storage unit;

a dimension setting unit that sets dimensions of desired portions of a component relating to the component information selected by the component information selection unit; and

a component joining unit that completes the shape of the structural object by joining components whose dimensions have been set by the dimension setting unit.

Also in order to achieve the above object, the present invention is constructed as follows. Specifically,

a program for defining the shape of a structural object used for defining a shape of a structural object such as a manhole in virtual space realized by a computer realizes on said computer:

a component information storage function of storing in storage unit component information relating to components forming the structural object;

a component information selection function wherein desired component information, of component information stored in the storage unit, is selected;

a dimension setting function wherein the dimensions of a desired portion, of a component relating to the component information selected by the component information selection function, are set; and

a component joining function wherein the shape of the structural object is completed by joining components whose dimensions have been set by the dimension setting function.

Herein “realizing” includes not merely the case where the various functions are realized by a single device but also the case where the various functions are realized divided among a plurality of devices.

Also “program” refers to an ordered series of instructions adapted for processing by a computer and includes programs installed on a computer HDD or CD-RW or the like and programs recorded on various types of recording media such as a CD-ROM, DVD, FD or computer HDD etc.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1A, FIG. 1B and FIG. 1C are views illustrating examples of previous pre-defined shapes;

FIG. 2 is an overall layout view of a structural object shape definition system 1 according to a first embodiment of the invention;

FIG. 3 is a view illustrating the construction of major parts of component information definition device 10, structural object shape definition device 20, structural object shape management device 30, and design drawings creation device 40;

FIG. 4 is a flow chart illustrating the processing of definition of the shape of a structural object using system 1 according to a first embodiment and completion of the shape of the structural object and views illustrating images of components in each step thereof;

FIG. 5 is an overall layout diagram of a design drawings creation system 2 according to a second embodiment of the invention; and

FIG. 6 is a flow chart illustrating the creation of design drawings using a system 2 according to the second embodiment and processing for completing the design drawings and a view illustrating an image of drawing creation in each step thereof.

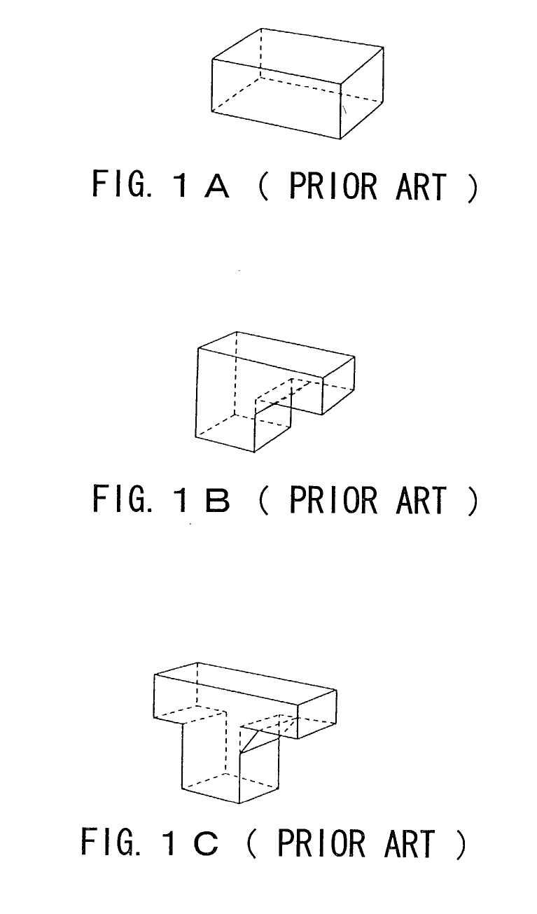

### DETAILED DESCRIPTION OF THE PREFERRED EMBODIMENTS

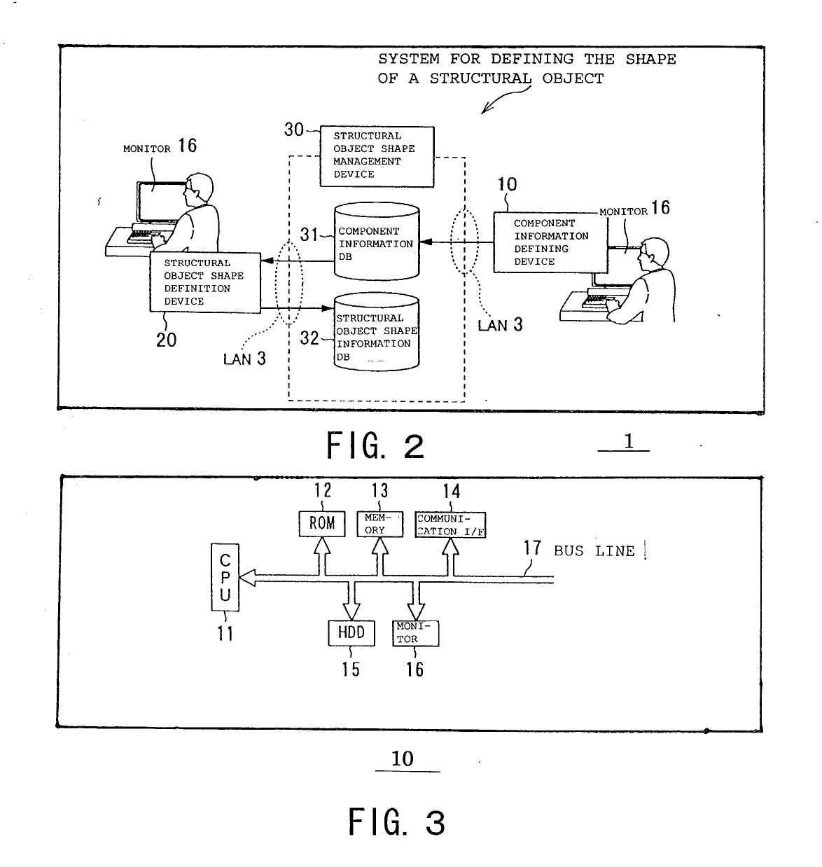

Referring now to the drawings, wherein like reference numerals designate identical or corresponding parts throughout the several views, and more particularly to FIGS. 2 to 4 thereof, one embodiment of the present invention will be described.

[First Embodiment]

FIG. 2 illustrates the overall layout of a structural object shape definition system 1. This structural object shape definition system 1 comprises a component information definition device 10, structural object shape definition device 20 and structural object shape management device 30, these being connected in such a way that they can mutually communicate by means of a communication circuit such as an LAN (local area network) or WAN (wide area network) 3.

FIG. 3 illustrates the construction of major parts of component information definition device 10. Component information definition device 10 consists in a workstation or personal computer or the like, comprising a CPU (central processing unit) 11 constituting a main control unit, ROM (read-only memory) 12 for storing beforehand fixed data such as a program that controls this CPU 11, memory (main memory) 13 forming an area for temporary storage of data of various types, communication interface 14 for transmitting data using a communication circuit such as aforesaid LAN 3, an HDD (hard disk drive) 15 in respect of which writing and reading of various types of data is performed and a monitor 16 such as a CRT or LCD etc. This CPU 11, ROM 12, memory 13, communication interface 14, HDD 15 and monitor 16 etc. are electrically connected by bus lines 17 such as an address bus and data bus.

Also, computer graphics software (program (p1)) is installed on HDD 15 so that a graphics screen can be displayed on monitor 16.

In addition, the program (p1) is a program for implementing various functions, to be later described, in structural component information definition device 10. By means of this, an operator can define and complete the shapes of components (primitive elements) forming the structural object in virtual space realized by component information definition device 10.

Since structural object shape definition device 10 comprises a workstation or personal computer or the like and is constructed of the same elements as the elements constituting the above component information definition device 10, the same reference symbols are employed in the following description and further description thereof is omitted.

In addition, computer graphics software (program (p2)) is installed on the HDD 15 of structural object shape definition device 20 so that a graphics screen can be displayed on monitor 16.

Also, program (p2) is a program for implementing various functions, to be described, in structural object shape definition device 20. By this means, an operator can define and complete the shape of a structural object by connecting components (primitive elements) forming a structural object in virtual space realized by structural object shape definition device 20.

Also, structural object shape management device 30 comprises a workstation or personal computer or the like and is constructed of the same elements as the elements constituting the above component information definition device 10, the same reference symbols are employed in the following description and further description thereof is omitted.

In addition, on HDD 15 of structural object shape management device 30, there are held component information files 31 relating to component information defined by component information definition device 10 and structural object shape information files 32 relating to structural object shape information defined by structural object shape definition device 20.

It should be noted that although the structural object shape definition system 1 comprises three devices 10, 20 and 30 on which the overall functionality is divided into three, there is no restriction to this and it could be constituted by a single device in which the overall functionality is combined into one, or two devices in which the overall functionality is divided into two, or four or more devices in which the overall functionality is divided into four or more.

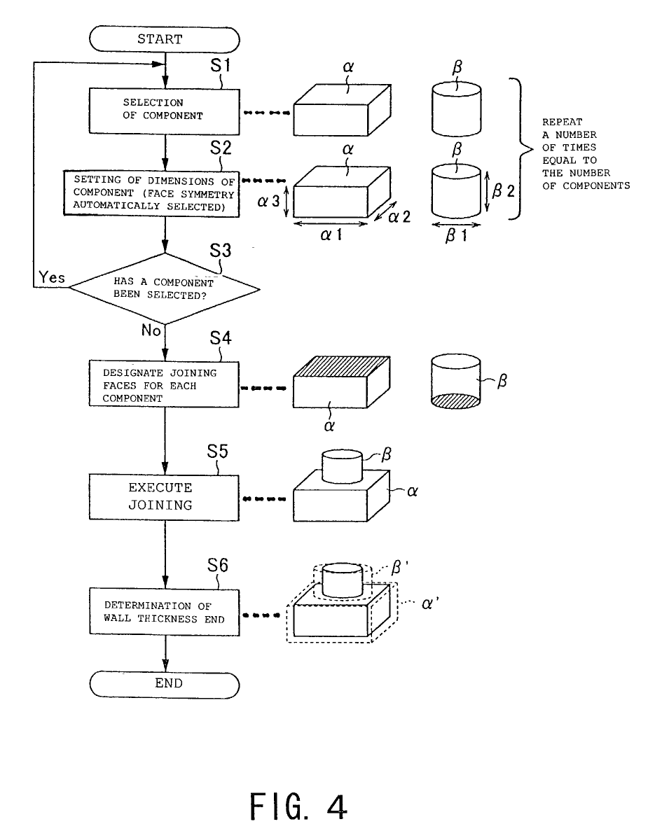

Next, using FIG. 4, a method of defining the shape of a structural object using the system 1 according to this embodiment will be described. FIG. 4 is a flow chart illustrating the processing for definition of the shape of a structural object using system 1 of the present embodiment and for completing the shape of a structural object and a view illustrating an image of a component in each step. Specifically, the image of a component in each step is illustrated on the right-hand side of each step.

Also, the operator defines beforehand a plurality of component shapes by implementing the component shape definition function in component information definition device 10 (this function is defined as p11), using the program (p1) and stores these as a component information file 31 in structural object shape management device 30 by implementing the component information storage function (this function is defined as p12). It should be noted that although the case was described wherein a plurality of component shapes are stored as a single component information files 31, there is no restriction to this and a single component shape could be stored as a single component information file while a plurality of items of component information could be stored as a plurality of component information files corresponding thereto.

Next, using program (p2) the operator selects components to form a structural object (step S1) by implementing the component information selection function in the structural object shape definition device 20 (this function is defined as p21).

This component selection is performed by selecting prescribed items of component information from component information file 31 of the structural object shape management device 30 by means of the component information selection function (this function is defined as p21). In FIG. 3, rectangular prism shape component α and cylindrical shape component β are illustrated on the right-hand side of step S1 as the images of the selected components.

Next, using program (p2), the operator sets (step S2) the dimensions of the various portions of the selected rectangular prism shape component 40 and cylindrical shape component 50 by implementing the dimension setting function in structural object shape definition device 20 (this function is defined as p22). In this example, the case is shown where, as the image for dimension setting, on the right-hand side of step S2, the three sides (α1, α1, α1) of the rectangular prism are set in the rectangular prism shape component and the diameter of the circle and height (β1, β2) are set in the cylindrical shape component β. Also, the names of the faces are automatically set by the automatic name setting function of program (p2) (this function is defined as p23), so that they can be utilized when designating junction (joining) faces in step S4, to be described.

Next, in step S3, if other components are to be selected (Yes), processing again returns to step S1. If all the components have been selected (No), processing advances to step S4. Then, when processing has advanced to step S4, the operator performs designation of the joining faces of each component (step S4) by implementing the component joining function in the structural object shape setting device 20 using program (p2) (this function is defined as p24). FIG. 4 shows the case where the top face of rectangular prism shape component α and the bottom face of cylindrical shape component β are designated on the right-hand side of step S4 as the designated images for the joining face. In this way, the shape of the structural object (hollow shape (a space being formed on the inside)) is completed (step S5) by executing joining of the components by joining the designated joining faces by implementing the component joining function (p24) in the structural object shape defining device 20. FIG. 4 shows the case where the top face of a rectangular prism shape component α and the bottom face of cylindrical shape component β are joined on the right-hand side of step S5 as the joining image of the joining faces. The co-ordinate information in units of the respective components (α, β) is held in respect of the joined structural object αβ.

Next, the operator determines the wall thickness of the completed structural object (step S6) by implementing the wall thickness determination function (this function is defined as p25) in structural object shape definition device 20, using program (p2). This determination of wall thickness is performed by structural object shape definition device 20 using numerical values of wall thickness that are input by the operator. In FIG. 4, the external shape of the structural object is shown by the broken line and the internal hollow shape of the structural object is shown by the continuous line on the right-hand side of step S6, in the image of wall thickness determination.

As described above, when designing an underground structural object such as a manhole, after first considering the mechanical equipment and cables etc. that are to be arranged within the structural object, the internal hollow shape is defined and shape definition of the structural object is completed by defining the wall thickness to be subsequently produced using concrete etc. After this, the operator sends the structural object shape information relating to the shape of the structural object which has thus been completed from the structural object shape definition device 20 to the structural object shape management device 30. In this way, the structural object shape information is stored as a structural object shape information file 32 in structural object shape management device 30.

As described above, by using the structural object shape definition system 1 according to this embodiment, the shape of the structural object is defined by joining a plurality of components, so even if there is a demand for definition of a shape of an underground structural object etc. departing greatly from the pre-defined shapes, shape definition can be performed flexibly and as far as possible without lowering the operating efficiency of structural object shape definition.

[Second Embodiment]

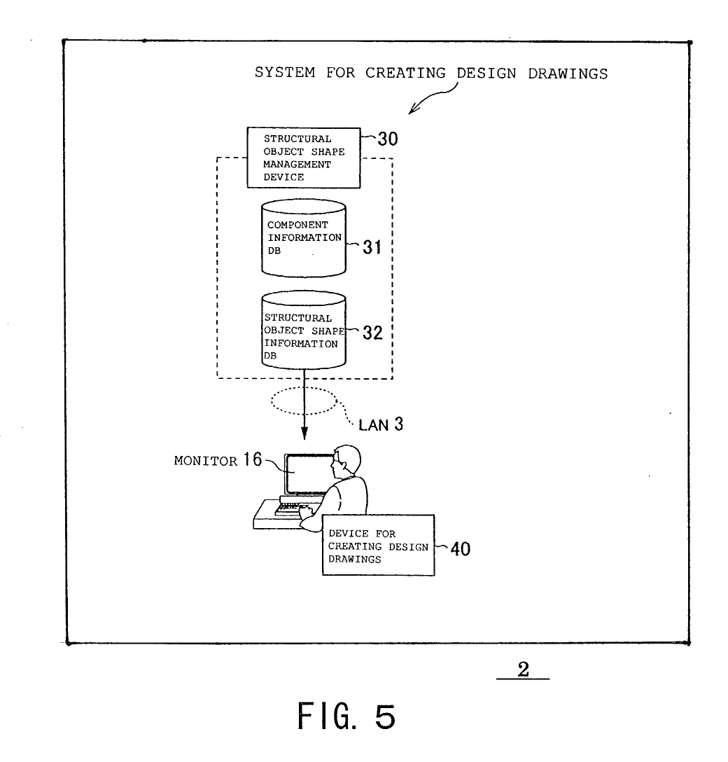

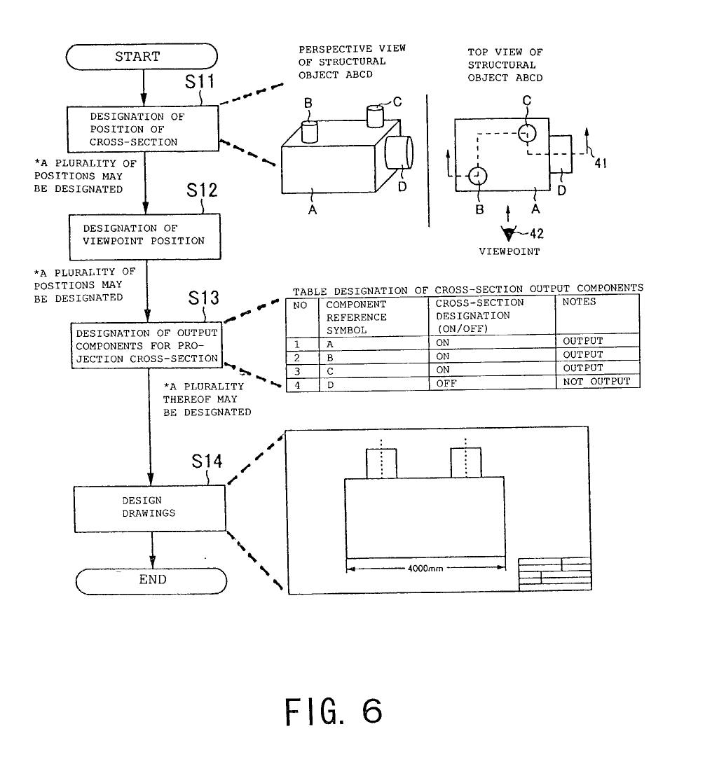

A design drawing creation system 2 relating to a second embodiment of the present invention is described below using FIG. 3, FIG. 5 and FIG. 6.

Design drawing creation system 2 is a system for creating design drawings using the structural object shape defined by structural object shape definition system 1 according to the first embodiment. Constituents which are the same as in the case of the first embodiment are given the same reference symbols and further description thereof is omitted.

FIG. 5 illustrates the overall layout of design drawing creation system 2. This design drawing creation system 2 comprises structural object shape management device 30 and design drawing device 40; these are connected so as to be capable of mutual communication by means of a communication circuit such as LAN or WAN 3.

Of these, design drawing creation device 40 comprises a workstation or personal computer or the like, the construction of whose main parts is the same as that of the main parts of component information definition device 10 described above; these are therefore given the same reference symbols in the following description and further description thereof is omitted.

In addition, computer graphics software (program (p4)) is installed on HDD 15 of design drawing creation device 40, so that a graphics screen can be displayed on monitor 16.

Also, program (p4) is a program for implementing various functions, to be described, on design drawing creation device 40. The operator can thereby create design drawings in the virtual space implemented by design drawing creation device 40.

It should be noted that although the design drawing creation system 2 comprises two devices 30 and 40 on which the overall functionality is divided into two, it could be constituted by a single device in which the overall functionality is combined into one, or three or more devices in which the overall functionality is divided into three or more. Also, structural object shape definition system 1 and design drawing creation system 2 could be integrated as a single system.

Next, a method of creating design drawings using the system according to this embodiment will be described using FIG. 6. FIG. 6 is a flow chart showing the processing for creating design drawings using system 2 of this embodiment and a view showing an image of drawing creation in each step. That is, images of drawing creation in each step are shown on the right-hand side of each step.

Also, the operator, by using beforehand program (p4) implements the structural object shape information reading function in design drawing creation device 40 (this function is defined as p41) and thereby reads structural object definition information file 32 of structural object shape management device 30 and selects a structural object to be the basis of the design drawings that are to be created. Let us assume that, as shown by a perspective view in FIG. 6, a structural object ABCD is selected formed by components A, B, C and D.

Next, the operator, using program (p4), implements the cross-sectional position designation function of design drawing creation device 40 (this function is defined as p42) and thereby designates the position of a cross-sectional plane of structural object ABCD (step S11). The designated image of the position of the cross-section illustrated on monitor 16 by design drawing creation device 40 is shown by broken lines 41 in the drawing of the top face of structural object ABCD shown on the right-hand side of step S11. A plurality of cross-sectional positions may be specified.

Next, the operator performs designation of the position of the viewpoint (step S12) by implementing the viewpoint designation function (this function is defined as p43) in design drawing creation device 40, using program (p4). FIG. 6 shows the position of viewpoint 42 in the lower part of the top face view of structural object ABCD, on the right-hand side of step S12, as the viewpoint position designation image.

In step S12 also, a plurality of viewpoint positions may be designated.

Next, the operator performs designation (step S13) of whether or not projection cross-sections are to be shown for each component (A, B, C, D) forming structural object ABCD, by implementing the projection cross-section designation function (this function is defined as p44) in design drawing creation device 40, using program (p4). These projection cross-sections are created by design drawing creation device 40 defining a projection light ray that passes through structural object ABCD from the viewpoint position specified in step S12 above and projecting the cross-sectional shape of structural object ABCD specified by step S4 onto a projection plane perpendicular to the aforesaid projection light ray.

Also, a component designation table for performing cross-sectional output designation for each component is shown on the right-hand side of step S13 as a component designation image for outputting a projection cross-section. In this case, a designation is made to output (ON) the cross-section of components A, B, C but not to output (OFF) the cross-section of component D. Thus, in step S13 also, outputs can be designated for each component i.e. a plurality of designations are possible.

Next, the operator implements the projection cross-section partial display function in design drawing creation device 14 (this function is defined as p45), using program (p4), thereby performing output of a design drawing (step S14) only of the designated projection cross-section, when this projection cross-section is displayed. In FIG. 6, the design drawing displayed on monitor 16 of design drawing creation device 40 is shown on the right-hand side of step S14 as the output image of the design drawing. Since in this case the dimensional information in respect of the completed structural object ABCD is held in individual component units by means of the dimensions of the components set in the above step S2, the width can be displayed as 4000 mm.

Since, as described above, by using the design drawings creation system 2 of this embodiment, the coordinate information in respect of the completed structural object ABCD can be held in units of the individual components, cross-sections can be drawn on the drawing making arbitrary cross-sections of the structural object. Design drawings can therefore also be generated from the defined structural object.

Structural analysis calculation can also be performed by linking the information of this structural shape object with a structure analysis calculation device (not shown). If this is done, the various load conditions etc. must be separately defined.

Also, since the numerical quantities in units of the members employed in the construction of the structural object can be found by including a member definition item as a property of the shape definition of this structural object, it is also possible to calculate the labor and materials costs etc. involved in constructing the structural object by linking this with building and engineering works price information. That is, processing for an integrated calculation of engineering works is also possible.

Furthermore, by defining the material properties of the members as an attribute of this structural object, when an order for definition of an underground structural object is received beforehand from a client, it is possible to make a proposal specifying not only the shape of the structural object but also its material properties.

Yet further, by defining the costs required for members as an attribute of this structural object, if a order for definition of an underground structural object is received beforehand from a client, it is possible to propose not merely the shape of the structural object but also the material properties and the costs required to procure this structural object.

Linkage with Structural Analysis Calculation

It should be noted that, when burying a structural object in the ground, it is sometimes necessary to carry out beforehand calculations regarding resistance to loads (soil pressure and water pressure etc.) received from the soil and the surface.

With a structural object defined using this structural object shape definition device, structure analysis calculation can be easily performed by calculating the coordinates of each member as attributes thereof.

As described above, with the present invention, since the shape of a structural object is defined by joining components, even if there is a request for definition of a shape of an underground structural object etc. that departs greatly from previously defined shapes, shape definition can be performed in a flexible manner and as far as possible without lowering the operating efficiency of structural object shape definition.

Obviously, numerous additional modifications and variations of the present invention are possible in light of the above teachings. It is therefore to be understood that within the scope of the appended claims, the present invention may be practiced otherwise than as specially described herein.

What is claimed is:

1. A device for defining a shape of a structural object in virtual space realized by a computer, comprising:
a component information storage unit that stores component information relating to components that form said structural object;
a component information selection unit that selects desired component information from said component information stored in said component information storage unit;
a dimension setting unit that sets dimensions of desired portions of a component selected by said component information selection unit; and
a component joining unit that completes said shape of said structural object by joining components whose dimensions have been set by said dimension setting unit.

2. The device according to claim 1,
wherein said component joining unit performs joining of components by specifying joining faces for each component whose dimensions have been set by said dimension setting unit and joining said components specified joining faces.

3. The device according to claim 1, further comprising:
a wall thickness determining unit that determines a wall thickness of said structural object completed by said component joining unit.

4. The device according to claim 1,
wherein said component information comprises a shape of said component.

5. The device according to claim 1,
wherein said component information comprises a material property of said component.

6. The device according to claim 1,
wherein said component information comprises a cost of said component.

7. The device according to claim 2, further comprising:
a wall thickness determining unit that determines a wall thickness of said structural object completed by said component joining unit.

8. A device for creating design drawings of a structural object in virtual space realized by a computer, comprising:
a component information storage unit that stores component information relating to components that form said structural object;
a component information selection unit that selects desired component information from component information stored in said component information storage unit;
a dimension setting unit that sets dimensions of desired portions of a component selected by said component information selection unit;
a component joining unit that completes said shape of said structural object by joining components whose dimensions have been set by said dimension setting unit;
a cross-sectional position designation unit that designates a position of a cross-section of said structural object completed by said component joining unit;
a viewpoint position designation unit that designates a position of a viewpoint on viewing a cross-section of said structural object designated by said cross-section position designation unit from a desired position; and
a projection cross-section display unit that creates a design drawing by displaying a projection cross-section of said structural object projected on viewing said cross-section of said structural object from said viewpoint position designated by said viewpoint position designation unit.

9. The device according to claim 8,
wherein said projection cross-section display unit comprises:
(a) a unit for specifying a projection cross-section that specifies whether or not to show a projection cross-section for each component forming said structural object, of said projection cross-sections of said structural object projected when viewing said cross-sections of said structural object from said viewpoint position designated by said viewpoint position designation unit; and
(b) a projection cross-section partial display unit that displays only a projection cross-section of a designated component when said projection cross-section is displayed by said projection cross-section designation unit.

10. A method of defining a shape of a structural object for defining said shape of said structural object in virtual space realized by a computer, comprising:
selecting a component stored in a component information storage unit;
setting a dimension of a portion of the selected component; and
joining the selected components so as to complete said shape of said structural object.

11. A computer program product for defining a shape of a structural object in virtual space realized by a computer, comprising:
a computer readable medium;
a component information storing instruction means for storing in a storage unit component information relating to components forming said structural object;
a component information selecting instruction means for selecting desired component information from said component information stored in said storage unit;
a dimension setting instruction means for setting dimension of desired portions of a component selected by said component information selecting instruction means; and
a component joining instruction means for completing said shape of said structural object by joining components whose dimensions have been set by said dimension setting instruction means; and wherein each of said instruction means is recorded on said medium.
